(19) United States
(12) Patent Application Publication
(10) Pub. No.: US 2010/0150641 A1
(43) Pub. Date: Jun. 17, 2010

(54) MULTI-FUNCTION ELEMENT FROM A SYSTEM FOR THE FILLING OR THE STORAGE OF AN ARTICLE

(76) Inventors: Stephane Wilpart, Lille (FR); Mohammed Zemmouri, Lille (FR)

Correspondence Address: SUGHRUE MION, PLLC, 2100 PENNSYLVANIA AVENUE, N.W., SUITE 800, WASHINGTON, DC, 20037, US

(21) Appl. No.: 12/530,398

(22) PCT Filed: Mar. 7, 2008
(86) PCT No.: PCT/IB08/02136

§ 371 Date: Feb. 17, 2010

(30) Foreign Application Priority Data
Mar. 9, 2007 (FR) 07/53742

(51) Int. Cl. B42F 13/02

(52) U.S. Cl. 402/19

(57) ABSTRACT

Multi-function element (1) from a system for the filling or the storage of an article, including a flange (2), comprising a central lobe (8), defined said central lobe (8) is flexible and can take two positions:
an unfolded position wherein it defines two dimensions:
   a distance between the top (10) of the lobe (8) and the longitudinal edge (5) smaller than the diameter of a suspension mean;
   a distance between the top (10) of the lobe (8) and the external edge (6) larger than the diameter of a punch of the article;
   a folded position wherein no part of the central lobe (8) defines a distance larger than the diameter of a punch of the article.

### FIELD OF THE INVENTION

The present invention relates to binding systems. More precisely, the invention is an element from a binding system which can be used in a multi-functional way.

### BACKGROUND OF THE INVENTION

Binding systems are widely used in offices or at home, to store articles (paper documents, compact discs, bags . . . ), which can be easily lost or damaged.

A large range of binding systems already exists, the most commonly found systems using punches, made on the documents to store or made on files (in cardboard, plastic, . . . ) with an opening for enclosing the articles. Binding means, for instance rings or rods, are inserted in punches. A locking device closes the binding means so that the articles are held in together and one article can be withdrawn by opening the binding means.

Classically, binding means are fixed in a rigid support, such as cardboard covers, in order to protect the documents. Then, the articles in their rigid protection can be stacked in pile.

This conception requires unlocking the locking device each time an article is to be withdrawn from the binding system or is to be stored inside the binding system.

Moreover, the locking device can increase the cost production of such binding systems by its potentially complicated construction.

In order to bring an element of solution, some binding systems comprise notches between the punches of an article and one edge of said article. These notches constitute an aperture for inserting a binding mean in a punch by a notch, and therefore it is not required to open the binding means.

The documents EP 0962335 and EP 1072439 both present such systems, wherein punches and notches are placed along one edge of a file. This edge being flexible, the notches can be opened and binding means can be inserted in the punches.

In order to facilitate the insertion of the binding means, the documents FR 1187509, US 2003165644 and GB 643124 propose to enlarge the portion of the notches the nearest to the edge.

Some binding systems comprise binding means which can be deformed by natural flexibility in order to be inserted in the punches, and without requiring implementing a locking device. The documents JP 10250278, EP 1005045 and EP 1162622 describe such system, in which a flange is placed on the rigid support. The flexibility of the flange allows to curve it and to pass it through the punches. Then, the flange comes naturally back against the articles.

Articles storing in binding systems such as described above can then be stacked in pile. Consequently, in order to find an article, it is necessary to move the binding systems above the one enclosing the desired article, causing tedious operation and potentially increasing the disorder.

To solve this problem, hanging systems have been implemented. The articles are stored vertically, next to each other, so that an article can be reached without effort.

A hanging system generally comprises a file, with an opening to insert an article—already in a binding system or not—and hooks to be placed on rails. In such systems, the articles can be stored without stacking them, facilitating their withdrawal.

The document DE 11 21 584 presents a hanging system, for binding means. The system comprises a front slot and a rear slot, placed along an edge. The front slot is made of two round holes, interpenetrating each other, and a notch allowing a binding mean to be inserted in the front slot. The rear slot is placed near a corner, so that a notch opens both on a lateral edge and on the superior edge. With this system, a first binding mean is inserted in the rear slot, and a second binding mean is forced into the front slot, in the further hole from the rear slot.

The document DE 909 931 relates to another hanging system, wherein a rod comprises means for being tightened to a file and hooks for being put on suspension rails.

With these systems, a user can therefore first put his documents in a binding system, and then, put them into storage, for a further utilisation.

However, all the presented systems cannot be used in another way than what they have been designated to: a binding system cannot be a suspension system and vice versa.

Moreover, one system usually has its own dimensions, so that it cannot be adapted on articles with different sizes. Indeed, for instance the distance between two punches of a leaflet or between two suspension rails, and their diameters, could be different from one manufacturer to another.

### SUMMARY OF THE INVENTION

It is an object of the invention to provide a system which can be used in a multi-way: as a binding system but also as a hanging system.

It is another object of the invention to propose a solution in order to adapt the system to different sizes of articles and of hanging means.

The proposed system comprises an element including a flange, enclosed between an outer edge and an inner edge substantially parallel to each other, one being far from the other by a distance smaller than or equal to the diameter d₁ of a leaflet punch. The system further includes a longitudinal edge substantially parallel to the flange edges and far from the inner edge by a distance equal to or larger than the diameter d₂ of a hanging mean. The flange edges extend from an extremity to join the longitudinal edge in an internal edge delimiting a full zone, the flange having a central lobe, defined between a central base and a central top, its base being positioned on a central part of the inner edge, at a distance from the internal edge larger than or equal to d₂. The central lobe is flexible and can take two positions:
an unfolded position wherein it defines two dimensions:
   a distance between the top of the lobe and the longitudinal edge smaller than d₂;
   a distance between the top of the lobe and the external edge larger than d₁;
a folded position wherein no part of the central lobe protrudes from the outer edge and from the inner edge, defining no distance larger than d1.

The flange being flexible, the lobe comes back in an unfolded position by natural flexibility.

Furthermore, the binding system according to the invention may comprises a second lobe whose dimensions allow the system to adapt to two hanging means and to two articles.

The present invention also relates to a device for making punches in articles, in particular in paper documents, comprising a base, a cutting die and a handle to make the die operate, the die having a form managed in order to cut the element in the article.

The above and other objects and advantages of the invention will become apparent from the detailed description of preferred embodiments, considered in conjunction with the accompanying drawings.

### BRIEF DESCRIPTION OF THE DRAWINGS

FIG. 1 is a front view of an element, in a first embodiment, of a system;

FIG. 2 is a front view of the element of FIG. 1 with a central lobe rolled into the folded position;

FIG. 3 is a front view of the element of FIG. 1 with a central lobe bent into the folded position;

FIG. 4 is a front view of a binding system for leaflets using the element of FIG. 1;

FIG. 4 bis is a detail view from an element of the binding system of FIG. 4;

FIG. 5 is a perspective view of a hanging system with suspension rails using the element of FIG. 1 fixed on folders;

FIG. 5 bis is a detail view from an element of the hanging system of FIG. 5;

FIG. 6 is a perspective view of a hanging system with rings binder using the element of FIG. 1 fixed on a folder;

FIG. 6 bis is a detail view from an element of the hanging system of FIG. 6;

FIG. 7 is a front view of an element, in a second embodiment, of the system;

FIG. 8 is a general view of a binding system with two elements placed on a folder;

FIG. 9 is a general view of the binding system of FIG. 3, with the elements in an inserting position, in a first step for binding a document;

FIG. 10 is a general view of the binding system of FIG. 3 in a second step for binding a document;

FIG. 11 is a detail view from FIG. 5 of an element;

FIG. 12 is a general view of the binding system of FIG. 3 in a third step for binding a document;

FIG. 13 is a detail view from FIG. 7 of an element;

FIG. 14 is a general view of the binding system of FIG. 3 in a fourth step for binding a document;

FIG. 15 is a detail view from FIG. 9 of an element;

FIG. 16 is a perspective view of system, in an inserting position, and comprising a handle;

FIGS. 17 to 21 are perspective views of the system, comprising different clamping devices;

FIG. 22 is a perspective view of the system, comprising a longitudinal aperture;

FIG. 23 is a perspective view of the system, comprising a sticking portion;

FIG. 24 is a perspective view of the system, comprising protruding elements for the assembling on a spiral notebook;

FIGS. 25 to 27 are perspective views of three consecutive steps of the assembling of two binding systems;

FIG. 28 is a perspective view of a cutting device.

### DESCRIPTION OF PREFERRED EMBODIMENTS

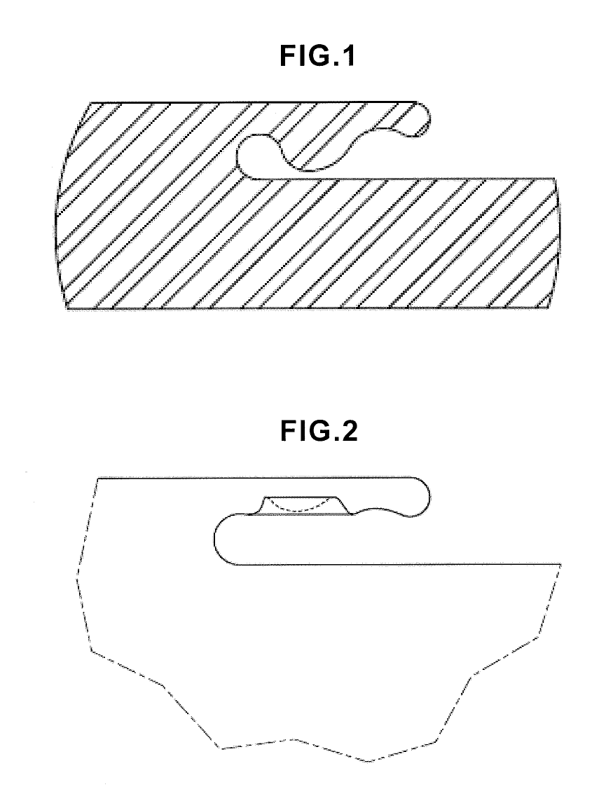

FIG. 1 presents the profile of an element 1 from a binding or a hanging system. The element 1 comprises a flange 2, enclosed between an outer edge 3 and an inner edge 4 substantially parallel to each other. The distance between the two edges 3 and 4 is smaller than or equal to the diameter, written d₁ for the following description, of a leaflet punch.

The diameter d₁ of punches can differ from an article to another, but they are commonly fixed by standards. For instance, the documents or the leaflet papers have the size and emplacement of their punches fixed by the international standard ISO 838, or the French standard NF Q09-001 or the German standard DIN 5005.

Substantially parallel to the flange edges, a longitudinal edge 5 extends at a distance from the inner edge 4 larger than or equal to the diameter, written d₂, of an element of a hanging mean.

Hanging mean refers here to any system accepting an article to come and hang on, such as rings, rods, suspension rails or any similar system. For instance, the size (diameter, distance between two means . . . ) of a hanging mean such as a ring is linked to the standards of punch diameters.

The inner edge 4 and the longitudinal edge 5 concur in an internal edge 6 delimiting a full zone 7. The internal edge 6 has a round shape, with a minimal radius of curvature larger than or equal to d₂.

When the system is not in use, the longitudinal edge 5, the internal edge 6, the inner edge 4 and the outer edge 3 substantially stand in a same plane, defined as the plane of the element.

Furthermore, the flange 2 comprises a central lobe 8, which is defined between a central base 9 and a central top 10, which extends in the element plane when not used. The base of the central lobe 8 is confounded with the inner edge 4.

Lobe refers here to any round-shaped protuberance, without sharp edges, so that it cannot damage an article.

In an unfolded position, the height of the lobe 8 is restrained by two dimensions. The first is the distance of the top 10 to the longitudinal edge 5 which is smaller than d₂. The second dimension is the distance of the top 10 above the outer edge 3, which is larger than d₁.

On an extreme part 11, the flange 2 holds an extreme lobe 12, whose top 13 is positioned at the inner edge 4 level, so that its distance to the inner edge 4 is smaller than or equal to d₁.

Between the two lobes 8 and 12, the inner edge 4 comprises a round-shaped recess 14, assuring a continuity of the inner edge 4 profile.

The central lobe 8 can be folded by using its flexibility. Two folded positions can be obtained, depending on the localisation of the flexibility, the positions being equivalent in their result. Indeed, as it will be explained further, the central lobe 8 is folded beyond its base 9, in order to have no part protruding from the outer edge 3 and from the inner edge 4, defining no distance larger than d₁, and no protruding part defining a distance with the longitudinal edge 5 smaller than d₂.

The flexibility means here the property of an article to be easily bent by one person without tools. The flexibility can be due, among other implementations, to the width, in conjunction or not with intrinsic properties of the used material. For example, some kinds of plastic, such as Polyethylene, or cardboard are easily flexible, even with a width of several centimetres, as they are already wildly used for this property. But it is also possible to have the required flexibility with more rigid materials, such as metallic materials, as long as the width does not reach more than some millimetres.

The first folded position (FIG. 2) is obtained by using the flexibility of the whole central lobe 8. The central lobe 8 is rolled up until no part of it protrudes above the inner edge 4 by a distance to the outer edge 3 larger than d₁.

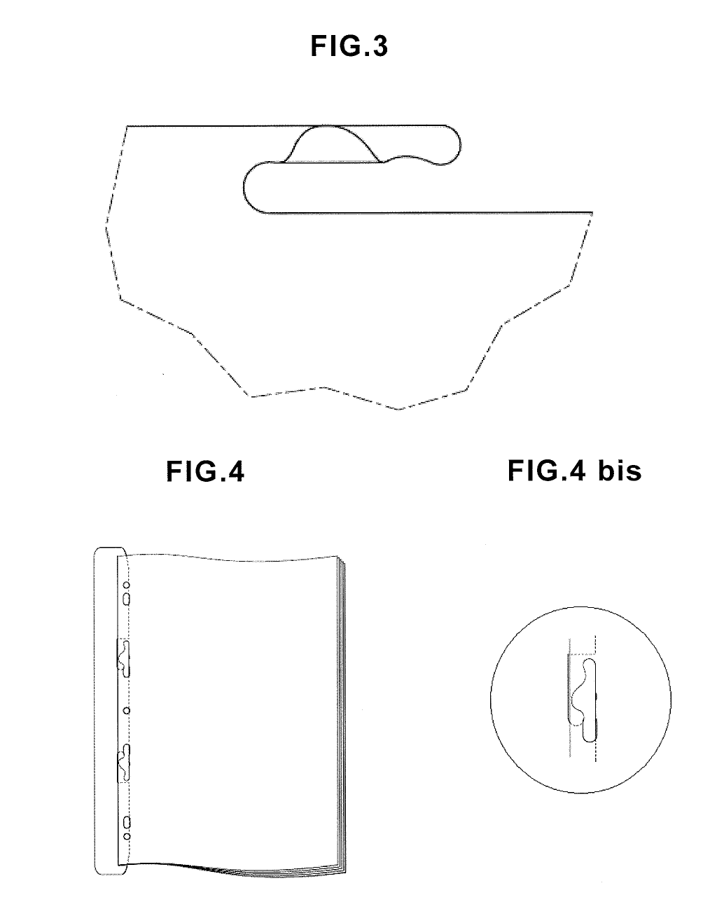

The second folded position (FIG. 3) is made by using the flexibility on a part of the central lobe 8, located around its base 9. For example, the lobe 8 can be thinned around its base 9. Then, the lobe 8 is bent, bringing its whole part against the outer and inner edges 3 and 4. It is required then that the central lobe 8 size between its top 10 and its base 9 is smaller than d₁, so that when it is folded no part protrudes from the outer edge 3.

Consequently, the element 1 can be used as a part of a binding system, as shown in FIG. 4: articles such as leaflets 15 comprising punches 16 can be adapted on the flange 2 as follow.

The extreme lobe 12 is inserted in a punch 16 until the leaflet 15 reaches the central lobe 8. The central lobe 8 is folded, so that the leaflet 15 can slide along the flange 2 until it is in abutment with the internal edge 6.

The lobe 8 comes back in the unfolded position by the natural spring return of the material, blocking the passage of the leaflet 15 from one side of the lobe 8 to the other side. Several leaflets 15 can be bind by one element 1 by inserting the flange 2 in one of their punches 16, the number depending on the width of the leaflets 15 and the distance between the central lobe 8 and the internal edge 6.

In a preferred embodiment, at least two elements 1 are used to be part of the binding system. They are placed on the same plane and along the same longitudinal edge 5.

Each element 1 can extend, in a first case, in the same direction as the other, an extreme lobe 12 being far from the next by a distance equal to the standardized distance between two punches, or they can extend, in a second case and as depicted on FIG. 4, in opposite directions, so that an extreme lobe is farther from the next than two punches from each other. In this second case, it is necessary to fold the flanges of the two elements in order to insert them in the punches. That is why the flange 2 presents flexibility near the full zone 7.

This flexibility allows the flange 2 to be lifted in an inserting position, wherein the outer and inner edges 3 and 4 leave the plane of the element 1 and are substantially perpendicular to the longitudinal edge 5. The flange 2 comes back in a position, by the natural spring return, wherein the outer and inner edges 3 and 4 are substantially parallel to the longitudinal edge 5. When the element is used in that way, the outer and inner edges 3 and 4 are not necessary in the same plane as the longitudinal edge, because they come in abutment with the article.

Accordingly, the element 1 manages to bind articles as follow.

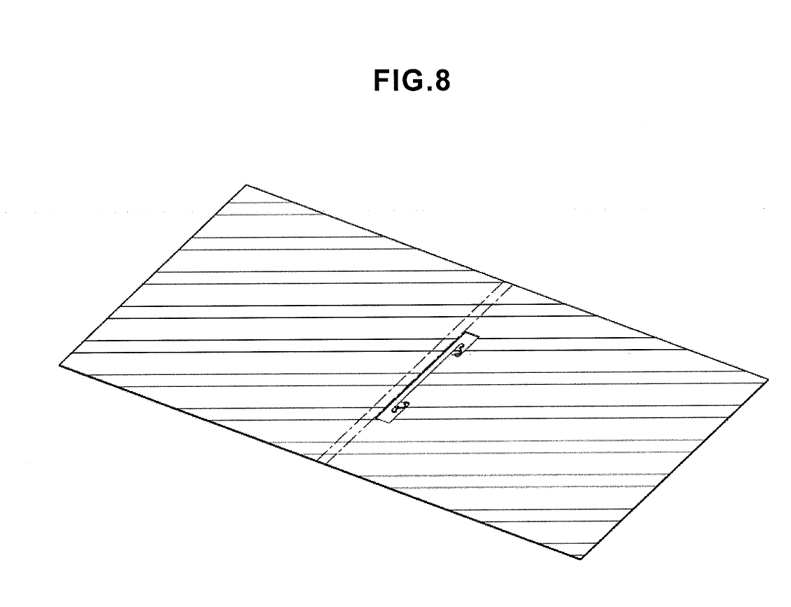

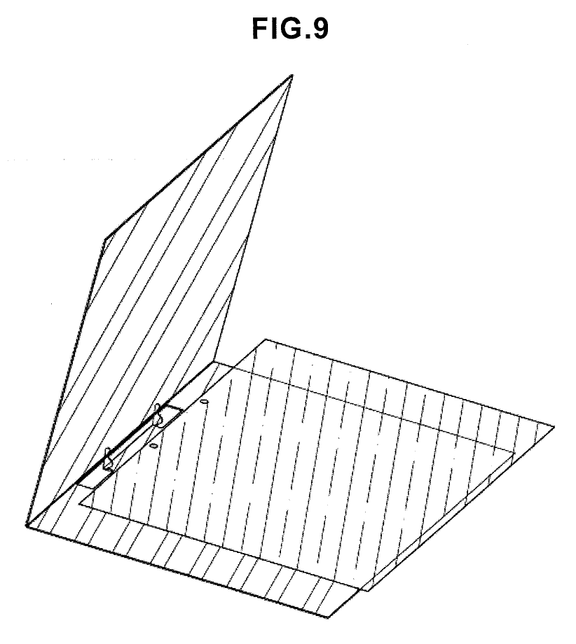

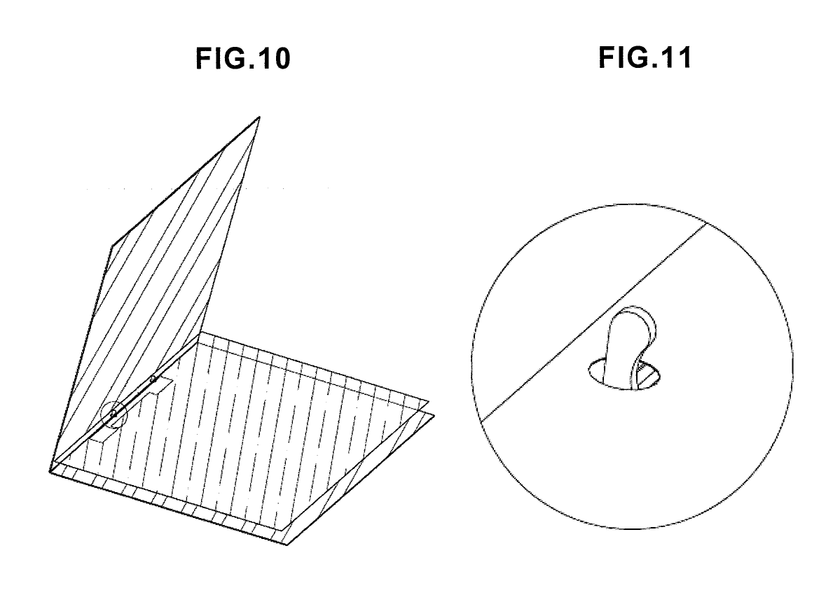

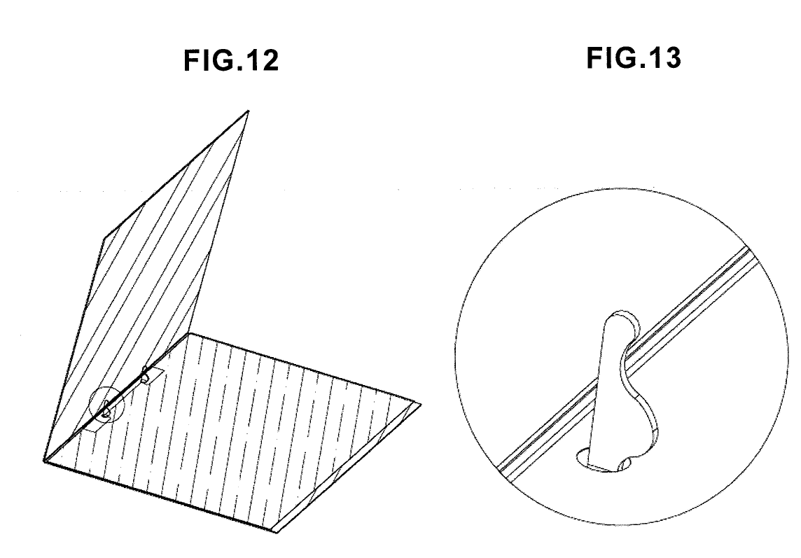

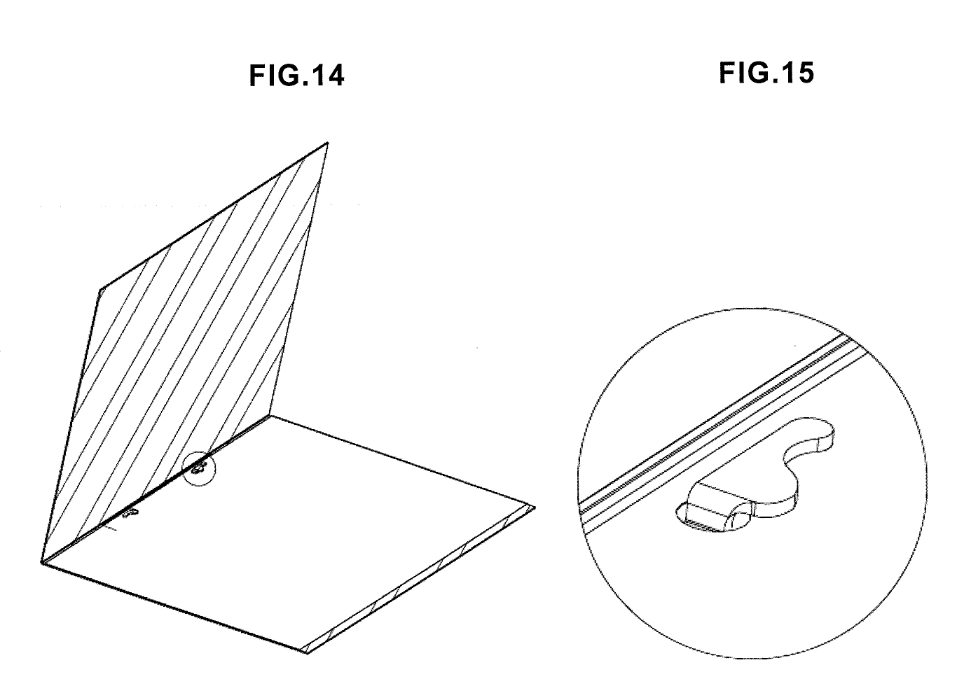

As depicted in FIG. 8, two elements 1 and 1′ are placed on a folder 20, along a same longitudinal edge 5, the flanges 2 and 2′ extending in opposite directions. The flanges 1 and 1′ are lifted in the inserting position (FIG. 9). The distance between the two extreme lobes 12 and 12′ in this position is equal to the standardized distance between two punches 22, for instance of a leaflet 21. The extremes lobes 12 and 12′ are inserted in the punches 22 (FIGS. 10 and 11), until the leaflet 21 comes in abutment with the central lobes 8 and 8′. The central lobes 8 and 8′ are folded, authorizing the punches 22 to continue to slide along the flanges 2 and 2′ until they arrive at the internal edges level, as it is shown on FIGS. 12 and 13. Then, the central lobes 8 and 8′ come back in the unfolded position, preventing the leaflet 21 from sliding, and the flanges 2 and 2′ come in abutment with the leaflet 21, which is thereon bound to the folder 20, as depicted on FIGS. 14 and 15.

Consequently, the leaflet 21 is secured by the system, any translation of the leaflet 21 along the longitudinal edge 5 being blocked between the central lobes 8 and 8′ and the internal edges.

As a matter of fact, elements 1 as many as there are punches 22 on the leaflet 21 can be implemented on the folder 20.

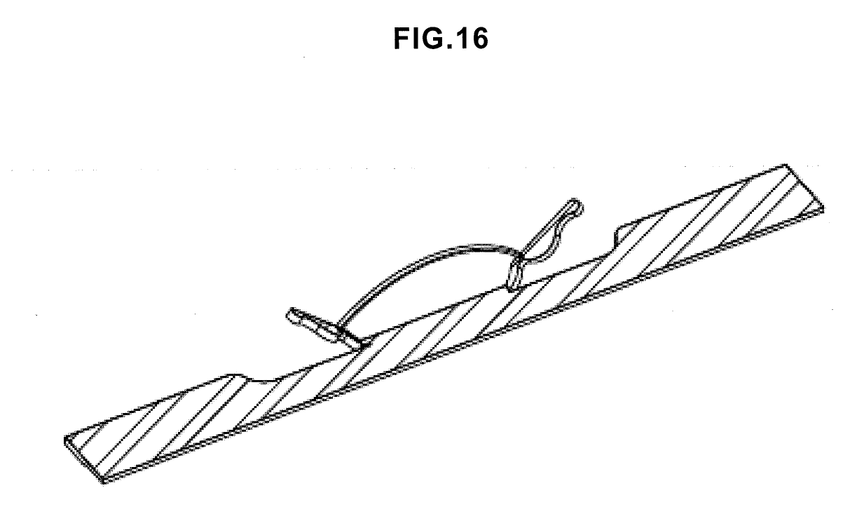

In order to put the flanges 2 and 2′ in the inserting position, an inserting handle 30 is fixed between two elements 1 and 1′, on the outer edges 3 and 3′, near the full zones 7 and 7′. By pulling the handle 30 in a direction substantially perpendicular to the elements 1 and 1′ plane, as shown in FIG. 16, the flanges 2 and 2′ are lifted.

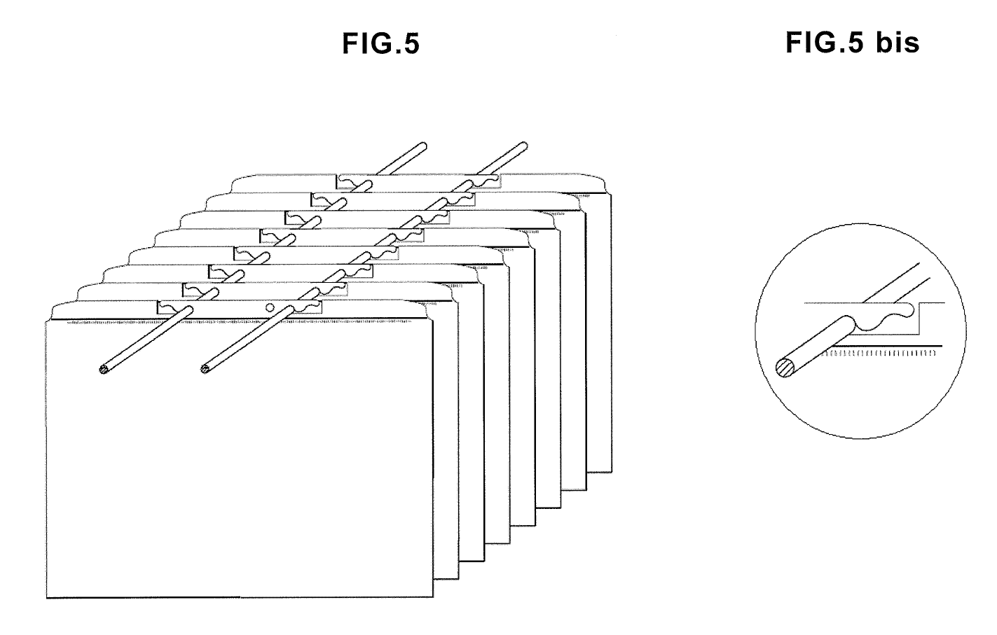

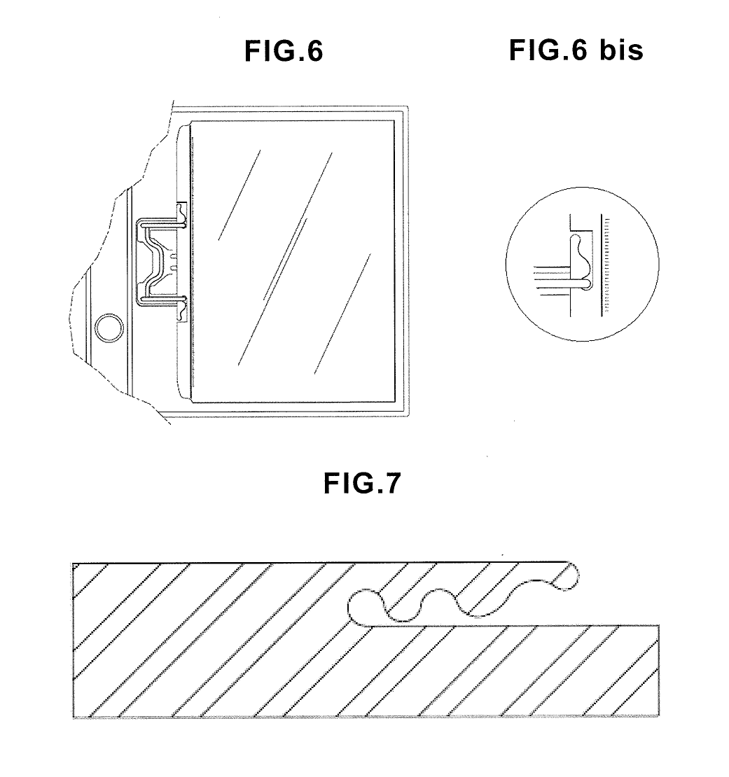

An element 1 can also be used as a part of a hanging system (FIGS. 5 and 6). Indeed, when the lobe 8 is in the folded position, a hanging mean such as a suspension rail 17 or a ring binder 18 can be inserted between the outer and the inner edges 3 and 4, to come between the central lobe 8 and the internal edge 6, in abutment with the longitudinal edge 5. When the central lobe 8 comes back in its unfolded position, the hanging mean is prevented from passing to the other side of the lobe 8. However, it is not a necessity to fold the central lobe 8 to insert the hanging mean. Indeed, this insertion can be done by folding the flange 2.

As for the binding system, in a preferred embodiment, at least two elements 1 are used to be part of the hanging system, and can extend, in a first case, in the same direction or, in a second case, in opposite directions.

In the second case, it is required to fold the flanges 2 to insert the hanging means in the two elements 1. Being folded in the inserting position, the hanging means can be placed against the internal edges, which are blocked when the flanges 2 comes back in the natural position, in the element plane. However, the flanges 2 can stand another position for accepting the insertion of the hanging mean.

Indeed, the flexibility near the full zone 7 also allows to slightly rotate a flange 2, in the plane of the element, around the full zone 7 in an accepting position, so that the flange 2 can be moved away from the longitudinal edge 5 until the top of the central lobe 8, in the unfolded position, is at a distance larger than or equal to d₂. As above, the flange 2 comes back in the natural position by natural spring return.

Consequently, the element 1 can be used as a part of a hanging system by inserting a hanging mean between the flange 2 and the longitudinal edge 5 as follow.

At least one element 1 is fixed along the longitudinal edge 5 to a pocket folder 19 or directly to the article. The pocket folder 19 comprises an aperture for the insertion of an article, and it can classically be in plastic or cardboard. From the natural position, the flange 2 is brought into the inserting or in the accepting position, allowing the hanging mean to pass the central lobe 8 and to come in abutment with the internal edge, which radius of curvature is able to receive the hanging mean. Then, the flange 2 comes back in its natural position, blocking the passage of the hanging mean from one side of the lobe 8 to the other side.

In a preferred embodiment, the hanging system comprises element 1 as many as there are hanging means.

In order to put two flanges 2 and 2′ in the accepting position, an accepting handle 31 is fixed between two elements, on the outer edges, near the full zone. This handle 31 can be the same as the inserting handle 30. By pulling the handle in a direction substantially in the plane of elements, the flanges are rotated.

In practice, whatever the system is considered to be, a binding or a hanging system, the longitudinal edge 5 is fixed to a rigid part, such as a rigid strip 40.

Consequently, when the system of the present invention is to be used as a hanging system, any binding system can be fixed on the rigid strip 40.

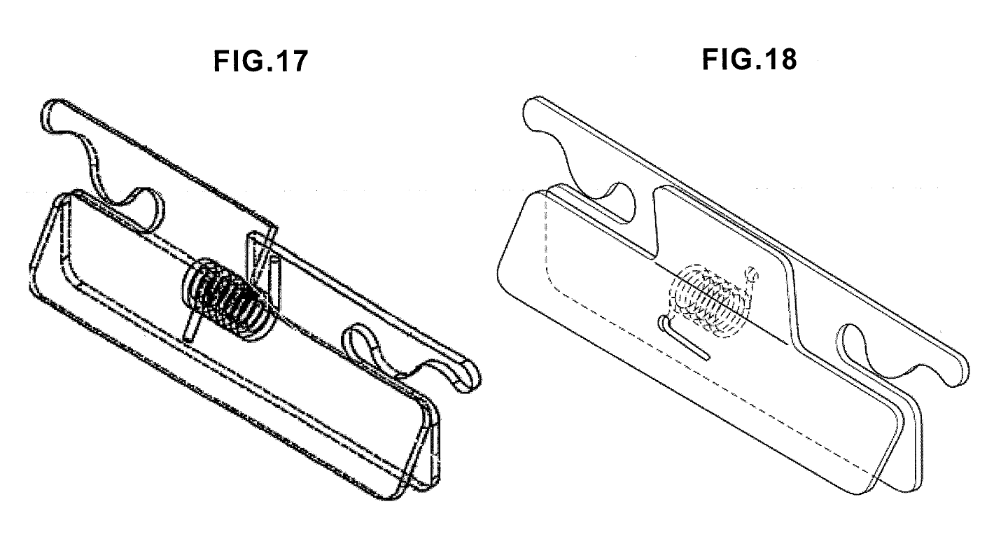

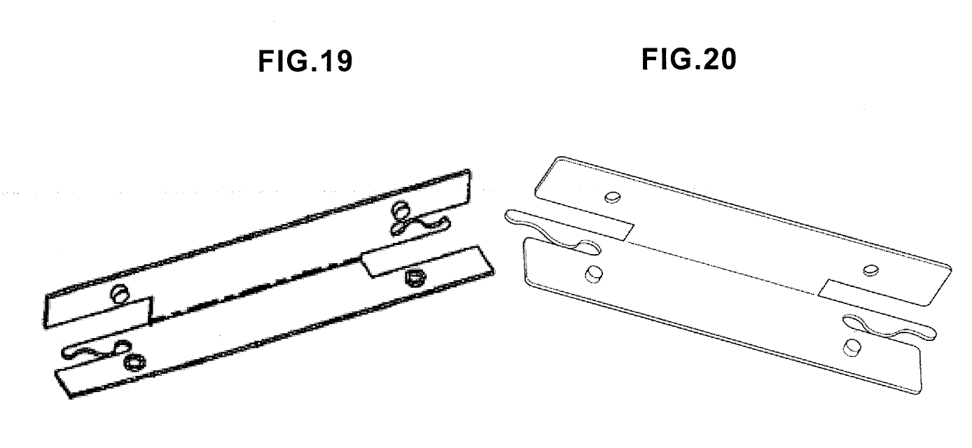

For instance, a clamping device 41 can serve as a binding system. The clamping device 41 comprises a second strip 42, fixed on the rigid strip 40 along the longitudinal edge 5, and articulated between an open position wherein it forms an angle with the rigid strip 40 and a closed position wherein it comes in abutment against the rigid strip 40. For instance, each strip comprises an element 1 (FIG. 17 and FIG. 19), so that an article such as a leaflet is clamped between the two strips 40 and 42 and then the system is hung on hanging means. One strip can also comprises every element 1 (FIGS. 18 and 20), so that the elements 1 are inserted in punches of articles and the strips 40 and 42 are hung by clamping.

In a first embodiment (FIGS. 17 and 18), the closed position is assured by a spring 43, placed between the two strips 40 and 42 and bringing them in the closed position.

In a second embodiment (FIGS. 19 and 20), on one strip, full buttons 44 are scattered on a face and away from each other by a distance that can be equal to the distance between two punches. The other strip comprises complementary empty buttons 45 facing the full buttons 44. Buttons of one strip can be inserted in punches of an article. Then the strips 40 and 41 are moved together, the full buttons 44 enter the empty buttons 44, locking the strips 40 and 42 together.

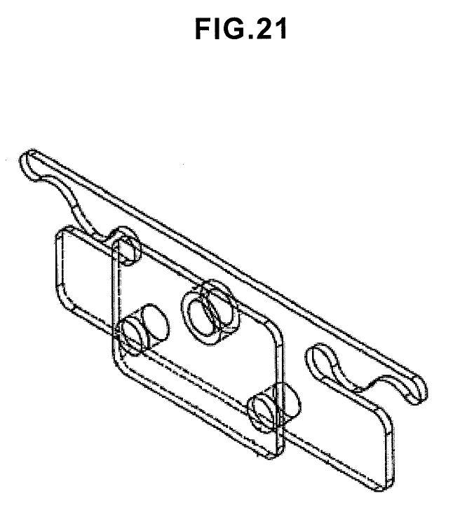

The two strips 40 and 42 can be joined and articulated along one edge (FIGS. 17 to 20), or they can be joined by buttons 46 and 47 (FIG. 21).

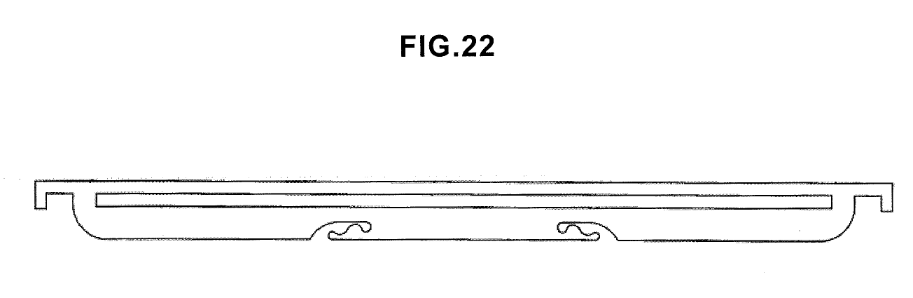

In a second instance, the rigid strip 40 includes an aperture 48 extending parallel to the longitudinal edge 5 (FIG. 22). An article can be inserted in the aperture 48 and then folded around the aperture 48 to be maintained inside. This conception is implemented, for instance, for an article without punches composed of two parts, joined along an edge, and folded along this same edge, such as double covers.

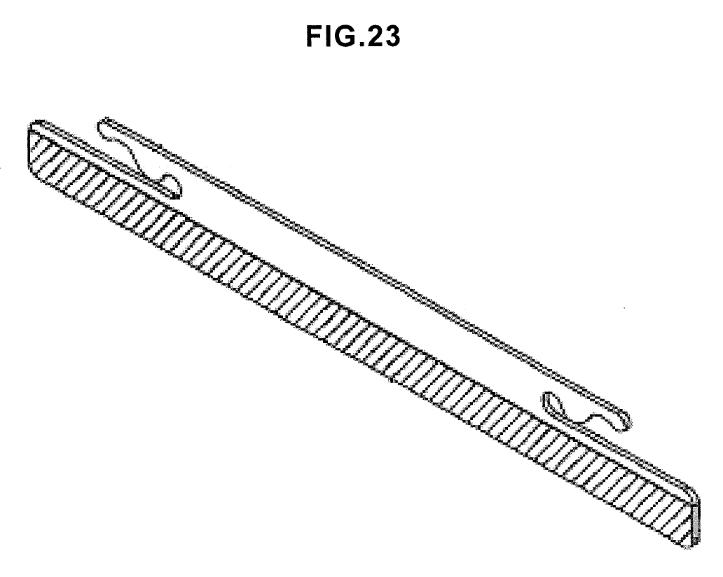

In a third instance, the rigid part 40 holds a sticking portion 49 protected by a film when not used (FIG. 23). In use, the film is removed to stick the system to an article.

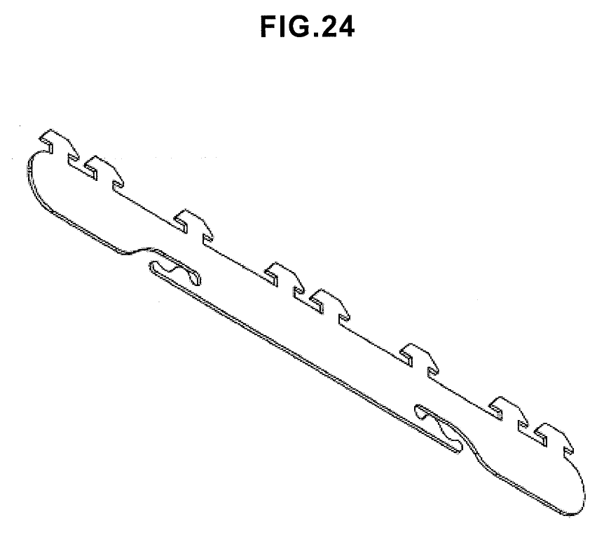

In a fourth instance, the rigid strip 40 comprises at least one protruding element 50, positioned on an edge 51 opposite to the longitudinal edge 5, said protruding element 50 having a first section 52 near the rigid strip 40 smaller than the distance between two spirals of a notebook and a second section 53 larger than the distance between two spirals (FIG. 24).

When the system is used as a binding system, any hanging system can be fixed to the rigid part. For instance, hooks 60 can be provided on extreme sides of the rigid part, extending in the plane of the elements 1a and 1b.

Moreover, the form of the element allows a third utilisation, which is the binding of two systems each comprising this element 1, by the association of the two elements 1. In this utilisation, it required that:
the distance between the outer edge 3a and the inner edge 4a of the element 1a of the first system is smaller than the distance between the inner edge 4b and the longitudinal edge 5b of the element 1b of the second system;
the distance between the top of the central lobe 8a and the outer edge 3a of the element 1a of the first system is larger than the distance between the inner edge 4b and the longitudinal edge 5b of the element 1b of the second system.

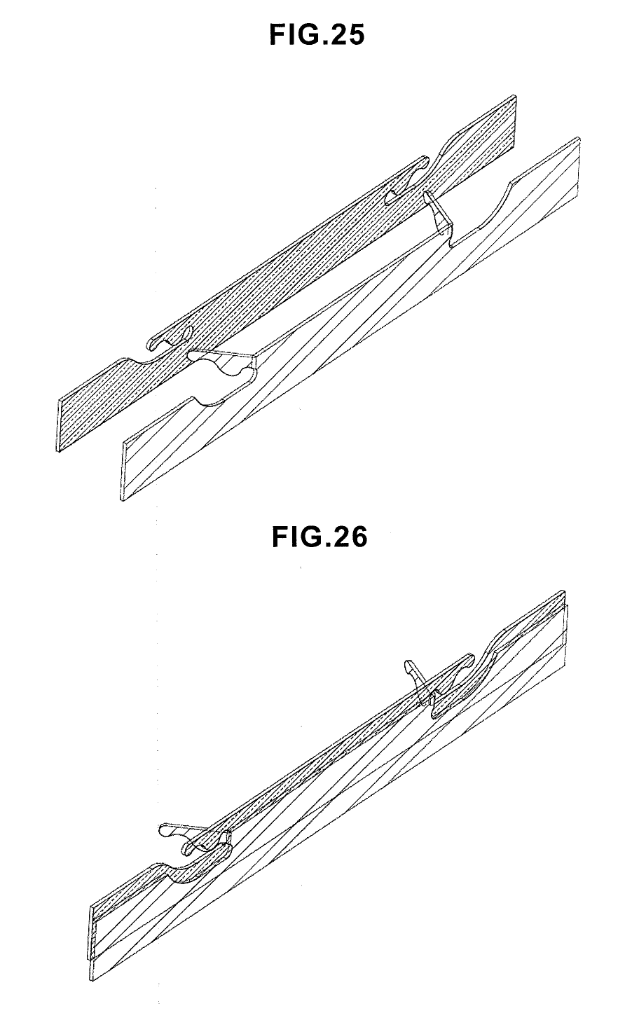

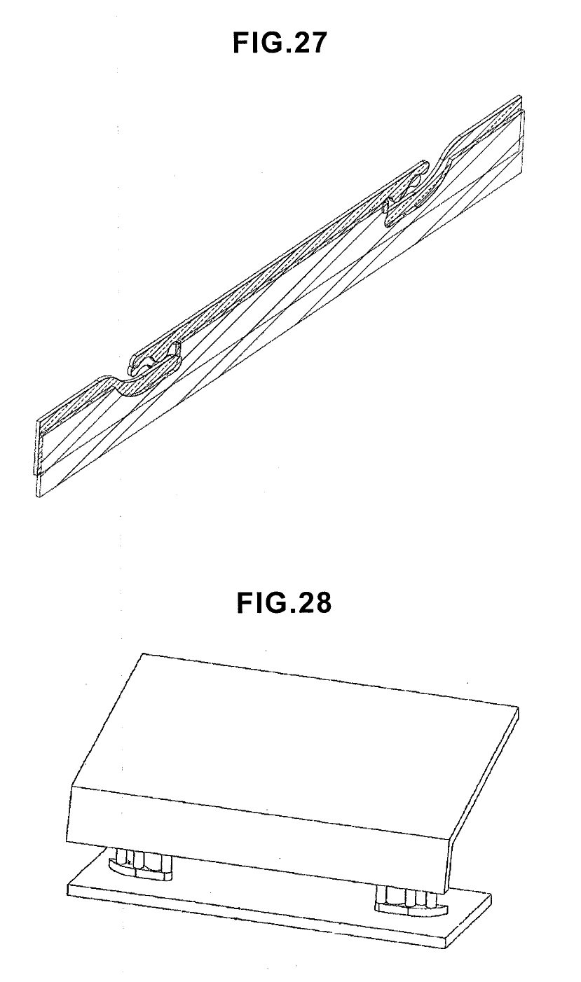

As depicted on FIGS. 25 to 27, it is possible to insert one flange 2a of a first element 1a between the longitudinal edge 5b and the inner edge 4b of the second element 1b. The insertion is managed as follow.

The first flange 1a is put in the inserting position. The lobe 8a of the first element 1a is folded too, and the portion of the flange 2a between the lobe 8a and the internal edge 6a of the first flange 2a is put in the area between the lobe 8b and the internal edge 6b of the second flange 2b. Then, the first flange 2a comes against the second element 1b. The elements 1a and 1b are then associated, the longitudinal edge 5a of the first element being on a side of the second element 1b opposite to the side on which the flange 2a is. They are preventing from dissociating by the two lobes 8a and 8b and the two internal edges 6a and 6b.

Accordingly, the element can be adapted for articles or hanging means of different sizes (FIG. 2).

In that purpose, a second lobe 70, defined between a second top 71 and a second base 72, is placed between the round-shaped recess 14 and the central lobe 8. As for the central lobe 8, the second lobe 70 has its base confounded with the inner edge 4. Between the two lobes 8 and 70, a round-shaped edge 73 has a minimal radius of curvature larger than or equal to the diameter of a hanging mean.

In a concern of clarity, the adaptability will be explained by an example, as follow.

In a binding system point of view, it is considered two articles, the first article having punches with a diameter d₁, two consecutive punches being at a distance D1 to each other and the second article having punches with a diameter d′₁, two consecutive punches being at a distance D′1 to each other. It is supposed that d₁ is smaller than d′₁ and that D1 is smaller than D′1.

The distance between the outer edge 3 and the inner edge 4 is smaller than or equal to d₁, the smaller of the diameters. The second lobe 70 can be put in the folded position, in order to have no element protruding from the outer edge 3 and from the inner edge 4, defining no distance larger than d₁. Then a first punch of the first article is positioned between the central lobe 8 and the internal edge 6, and the central lobe 8 is folded too so that a first punch of the second article is positioned between the two lobes 8 and 70.

A second element of the same conception is then positioned along the same longitudinal edge 5 with respect to the distances D1 and D′1:
the distance between two middle areas 74 between the central lobe 8 and the internal edge 6 is substantially equal to D1;
the distance between two middle areas 75 between the two lobes 8 and 70 is substantially equal to D′1.

In a hanging system point of view, it is considered two kinds of hanging means, the first mean having a diameter d₂ smaller than the diameter d′₂ of the second mean. It is also considered that two means with the diameter d₂ are separated by a distance D2, and two means with the diameter d′₂ are separated by a distance D′2, larger than D2.

Consequently, the distance between the inner edge 4 and the longitudinal edge 5 is larger than or equal to d′₂, the larger of the diameters. Between the central lobe 8 and the second lobe 70, the inner edge 4 holds the round shape 73 whose minimal diameter is equal to d′₂, and between the central lobe 8 and the full zone 7, the internal edge 6 forms a minimal diameter equal to d₂.

The top 10 of the central lobe 8 is, in the unfolded position, at a distance to the longitudinal edge 5 smaller than d₂ and the second lobe 70 is, in the unfolded position, at a distance to the longitudinal edge 5 smaller than d′₂.

This second lobe 70 can also be folded as the central lobe 8, beyond its base, in order to have no element protruding from the inner edge 4, defines a distance with the longitudinal edge smaller than d₂.

Moreover, when a second element 70 with the same conception is used, it is placed with respect to the distances D2 and D′2:
the distance between two middle areas 74 between the central lobe 8 and the internal edge 6 is substantially equal to D2;
the distance between two middle areas 75 between the two lobes 8 and 70 is substantially equal to D′2.

The flange 2 can always be rotated in the inserting position or on the accepting position in which the hanging with diameter d′₂ pass the second lobe 70 and the hanging mean with the diameter d₂ pass the second lobe 70 and the central lobe 8.

Consequently, one system can be adapted on two standards of hanging means and on two standardized articles, by being blocked between the two lobes 8 and 70 and between the central lobe 8 and the internal edge 6.

Accordingly, the invention proposes a device 80 for cutting in an article the element.

The device comprises a base 81, a die 82 and a handle 83 for operating the die 82. The die 81 presents, on a cutting face, a form 84 allowing cutting on an article the multi-function element. A distance larger than or equal to the width of the article is managed between the base 81 and the cutting face of the die 81. The article is positioned on the base 81, with its edge to be cut under the die 82. By pushing the handle 83, the die 82 is lowered until it penetrates the article, cutting the element. When the die is in abutment with the base 81, the article is perforated right through. Then, the handle 83 is lifted, causing the die 82 to lift too and the article can be removed from the device 80.

In an embodiment, the base 81 comprises a receptacle for the cut parts of the article.

The cutting device 80 can be implemented in particular for paper documents, which could then be directly stored on hanging means, and especially in folder with hanging means such as rings.

The element 1 of present invention can be used in a multi-function way. Indeed, the flexible central lobe 8, restrained by the two dimensions, blocks both an article with punches and a hanging mean, so that an element 1 can be used as a part of a binding system, or of a hanging system.

Two elements 1 can also be used to bind two systems holding an element 1.

The element 1 also presented an increased adaptability to different standardized supplies.

INDEX

| 1/1′/1a/1b | element |
|---|---|
| 2/2′/2a/2b | flange |
| 3/3′/3a/3b | outer edge |
| 4/4a/4b | inner edge |
| 5/5a/5b | longitudinal edge |
| 6/6a/6b | internal edge |
| 7/7′ | full zone |
| 8/8′/8a/8b | central lobe |
| 9 | central base |
| 10 | central top |
| 11 | extreme part |
| 12/12′ | extreme lobe |
| 13 | top |
| 14 | recess |
| 15 | leaflet |
| 16 | punch |
| 17 | suspension rail |
| 18 | ring binder |
| 19 | pocket folder |
| 20 | folder |
| 21 | leaflet |
| 22 | punch |
| 30 | inserting handle |
| 31 | accepting handle |
| 40 | rigid strip |
| 41 | clamping device |
| 42 | second strip |
| 43 | spring |
| 44 | full buttons |
| 45 | empty buttons |
| 46 | buttons |
| 47 | buttons |
| 48 | aperture |
| 49 | sticking portion |
| 50 | protruding element |
| 51 | edge |
| 52 | first section |
| 53 | second section |
| 60 | hook |
| 70 | second lobe |
| 71 | second top |
| 72 | second base |
| 73 | round shaped edge |
| 74 | middle area |
| 75 | middle area |
| 80 | cutting device |
| 81 | base |
| 82 | die |
| 83 | handle |
| 84 | form |

1. System for the filling or the storage of an article, comprising an element (1), including a flange (2), enclosed between an outer edge (3) and an inner edge (4) substantially parallel to each other, one being far from the other by a distance smaller than or equal to the diameter d₁ of a leaflet punch, the system further including a longitudinal edge (5) substantially parallel to the flange edges (3) and (4) and far from the inner edge (4) by a distance equal to or larger than the diameter d2 of a hanging mean, the flange (2) edges (3) and (4) extending from an extremity to join the longitudinal edge (5) in an internal edge (6) delimiting a full zone (7), the flange (2) having a central lobe (8), defined between a central base (9) and a central top (10), its base (9) being positioned on a central part of the inner edge (4), at a distance from the internal edge (6) larger than or equal to d₂, the system being characterized in that said central lobe (8) is flexible and can take two positions:
an unfolded position wherein it defines two dimensions:
a distance between the top (10) of the lobe (8) and the longitudinal edge (5) smaller than d₂;
a distance between the top (10) of the lobe (8) and the external edge (6) larger than d₁;
a folded position wherein no part of the central lobe (8) protrudes from the outer edge (3) and from the inner edge (4), defining no distance larger than d1.

2. System according to claim 1 wherein the central lobe (8) is flexible from its base (9) to its top (10), so that it can be rolled up in the folded position.

3. System according to claim 1 wherein the central lobe (8) is flexible around its base (9), and wherein its size between its top (10) and its base (9) is smaller than d₁ so that it is bent in the folded position by bringing it against the outer and inner edges (3) and (4) without any part to protrude from the outer edge (3).

4. System according to claim 1 wherein the central lobe (8) comes back in the unfolded position by natural elasticity return.

5. System according to claim 1 wherein the flange (2) comprises a flexible part near the full zone (7), allowing to be lifted in an inserting position, wherein the outer and inner edges (3) and (4) extend in a direction substantially perpendicular to plane of the element.

6. System according to claim 5 wherein the flange (2) is rotated around the full zone (7) in an accepting position wherein the flange (2) is moved apart from the longitudinal edge (5), in the plane of the element (1), managing a distance between the central lobe (8) and the longitudinal edge (5) larger than or equal to d₂.

7. System according to claim 5 wherein the flange (2) edges come back by natural elasticity return in a position substantially parallel to the longitudinal edge (5).

8. System according to claim 1 comprising at least two elements (1) disposed along the same longitudinal edge (5) and in the same plane, and orientated in the same direction.

9. System according to claim 5 comprising at least two elements (1) disposed along the same longitudinal edge (5) and in the same plane, and orientated in opposite directions.

10. System according to claim 9, comprising a handle (30,31) fixed between the two elements (1), on their outer edges (3), near their full zone (7).

11. System according to claim 1 wherein an element (1) comprises a second lobe (70), defined between a second top (71) and a second base (72), said base (72) being confounded with the inner edge (4), the second lobe (70) defining:
a round-shaped edge (73) between the second lobe (70) and the central lobe (8), on the inner edge (4), with a minimal diameter larger than or equal to the diameter d′2 of a hanging mean;
a distance between the top (71) of the second lobe (70) and the longitudinal edge (5) smaller than d′₂;
a distance between the top (71) of the second lobe (70) and the outer edge (3) larger than the diameter d′₁ of a punch of an article; the second lobe (70) being flexible into a folded position wherein no part of the second lobe (70) protrudes from the outer edge (3) and from the inner edge (4), defining no distance larger than d′₁.

12. System according to claim 1 comprising a rigid strip (40) fixed to the longitudinal edge (5), said rigid strip (40) being fixed to a binding system.

13. System according to claim 1 comprising a rigid strip (40) fixed to the longitudinal edge (5), said rigid strip (40) being fixed to a hanging system.

14. System according to claim 12 wherein the rigid strip (40) comprises a clamping device (41) for holding articles.

15. System according to claim 14 wherein the clamping device (41) includes a second strip (42) articulated along the longitudinal edge (5) in regard with the rigid strip (40), between an open position in which the second strip (42) forms an angle with the rigid strip (40) and a closed position in which the second strip (42) comes in abutment against the rigid strip (40).

16. System according to claim 15 wherein the clamping device (41) further comprises a spring (43) maintaining the clamping device (41) in the closed position.

17. System according to claim 14 comprising a second strip (42), and wherein one strip comprises full buttons (44), away from each other with respect to the distance between leaflet punches, facing complementary empty buttons (45) held by the other strip, the buttons diameter being equal to or smaller than the punch diameter.

18. System according to claim 12 comprising an aperture (48) on the rigid strip (40) running along the longitudinal edge (5).

19. System according to claim 12, wherein the rigid strip (40) comprises a sticking portion (49).

20. System according to claim 12 wherein the rigid strip (40) comprises at least one protruding element (50) for binding articles with spirals, such as spirals notebooks, positioned on an edge (51) opposite to the longitudinal side (5), said protruding element (50) having a first section (52) near the rigid strip (40) smaller than the distance between two spirals of a notebook and a second section (43) larger than the distance between two spirals.

21. System according to claim 12 wherein the rigid strip (40) is fixed to a pocket folder (19) and (20), such as plastic folder or cardboard folder, said folder comprising an aperture for the insertion of an article.

22. System according to claim 12 wherein the rigid strip (40) comprises hooks (60) for rails positioned on its extremities, extending substantially perpendicularly to the longitudinal edge (5), in the same plane as the flange (2).

23. Two systems according to claim 1, wherein the two systems are associated, by folding the flange (2a) and the lobe (8a) of an element (1a) of the first system, and then inserting it between the inner edge (4b) and the longitudinal edge (5b) of an element (1b) of the second system.

24. Device (80) for making punches in articles, in particular in paper documents, comprising a base (81), a cutting die (82) and a handle (83) to make the die (82) operate, characterized in that the die (82) has a form managed in order to cut in the article the element (1) according to claim 1.
